(19) United States
(12) Patent Application Publication
(10) Pub. No.: US 2026/0127440 A1
(43) Pub. Date: May 7, 2026

(54) System and Method for Progressive Learning Using Iterative Assessment and Generation

(71) Applicant: Theodore Orlin Cochran, Centennial, CO (US)

(72) Inventor: Theodore Orlin Cochran, Centennial, CO (US)

(21) Appl. No.: 18/964,674

(22) Filed: Mar. 21, 2025

(51) Int. Cl. G06N 3/086; G06N 3/092

(52) U.S. Cl. CPC G06N 3/086; G06N 3/092

(57) ABSTRACT

A system and method for progressive learning using iterative assessment and generation is provided. The system employs transformer-based models to generate domain-specific learning interactions and assess responses, with parameters being continuously updated based on effectiveness metrics and demonstrated mastery. An iterative learning cycle generates interactions, evaluates responses to determine both knowledge states and interaction quality, and updates system parameters accordingly, progressively improving both learning interactions and knowledge states. The system supports dual-mode operation for both human and machine learning, with a meta-learning framework that analyzes patterns across multiple domains, transfers successful learning strategies, and continuously enhances teaching effectiveness through systematic analysis of cross-domain learning outcomes. The invention enables simultaneous improvement of learning materials and learner knowledge, creating synergies between human and machine learning approaches.

### CROSS-REFERENCE TO RELATED APPLICATIONS

[Not applicable—this is a new application with no related applications]

### STATEMENT REGARDING FEDERALLY SPONSORED RESEARCH OR DEVELOPMENT

[Not applicable—no federal sponsorship]

### NAMES OF THE PARTIES TO A JOINT RESEARCH AGREEMENT

[Not applicable—no joint research agreement]

### BACKGROUND OF THE INVENTION

### Field of the Invention

The present invention relates generally to computer-implemented learning systems and, more particularly, to systems and methods for progressive learning through iterative content generation and assessment.

### Description of Related Art

Traditional learning systems typically employ static content delivery methods that fail to adapt effectively to individual learning needs or evolving knowledge domains. Many existing systems separate content generation from assessment, treating them as distinct processes rather than complementary components of a unified learning cycle.

Existing adaptive learning technologies often rely on pre-defined content repositories with limited ability to generate novel learning materials. While some systems incorporate basic personalization, they typically lack sophisticated mechanisms for progressive difficulty adjustment based on demonstrated mastery.

Machine learning approaches have increasingly been applied to educational technology, yet most focus exclusively on either human learning or machine training, without recognizing the potential synergies between these domains. Traditional systems that do employ machine learning often rely on conventional neural network architectures rather than leveraging transformer-based models for both content generation and assessment.

There remains a need for learning systems that can seamlessly integrate content generation and assessment in a continuous, iterative cycle that progressively improves both the quality of learning interactions and the knowledge state of learners, whether human or machine.

### BRIEF SUMMARY OF THE INVENTION

The present invention provides systems and methods for progressive learning through iterative content generation and assessment. In various embodiments, the invention employs transformer-based models to generate domain-specific learning interactions and assess responses, with parameters being continuously updated based on effectiveness metrics and demonstrated mastery.

In one aspect, the invention comprises a computer-implemented method for progressive learning that executes an iterative learning cycle. The cycle generates learning interactions, evaluates responses to determine both knowledge states and interaction quality, and updates system parameters accordingly. This cyclical process progressively improves both the effectiveness of the learning interactions and the knowledge state of the responding entity.

In another aspect, the invention provides a unified system for both human and machine learning. The system maintains a transformer-based model capable of operating in dual modes: a human learning mode that facilitates expertise development and a machine learning mode that trains other artificial intelligence systems. The system improves its content generation capabilities through analysis of interactions in both modes.

In yet another aspect, the invention implements a meta-learning framework for domain-independent expertise development. The framework analyzes patterns across multiple domains, transfers successful learning strategies, and continuously enhances its teaching effectiveness through systematic analysis of cross-domain learning outcomes.

The present invention represents a significant advancement over prior art by integrating generation and assessment in a unified learning framework, supporting both human and machine learning through the same underlying architecture, and implementing meta-learning capabilities for cross-domain optimization.

### BRIEF DESCRIPTION OF THE DRAWINGS

FIG. 1 is a block diagram illustrating a system architecture overview.

FIG. 2 is a flow diagram depicting an iterative learning cycle.

FIG. 3 is a block diagram showing dual-mode operation for human and machine learning.

FIG. 4 is a graph illustrating progressive difficulty adjustment over time.

FIG. 5 is a block diagram depicting knowledge state tracking through interconnected nodes.

FIG. 6 is a block diagram illustrating a meta-learning framework with cross-domain transfer.

FIG. 7 is a flow diagram showing the parameter update process.

FIG. 8 is a block diagram depicting the layered system implementation architecture.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

### System Architecture Overview

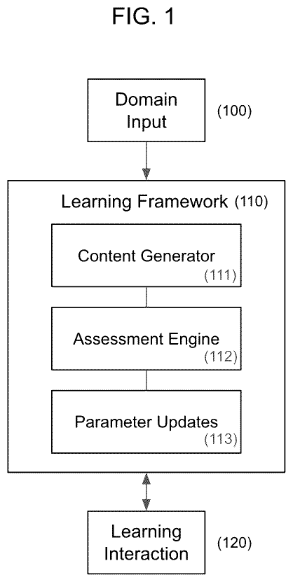

Referring to FIG. 1, a system architecture overview is illustrated wherein a domain input (100) feeds into a learning framework (110). The domain input (100) specifies the field of expertise for which learning interactions will be generated. This may include subject matter definitions, success criteria, key concepts, and evaluation parameters.

The learning framework (110) comprises three primary components: a transformer-based content generator (111), an assessment engine (112), and a parameter updates module (113). The content generator (111) employs transformer-based language models to produce contextually appropriate learning interactions based on current system parameters and the specified domain.

The assessment engine (112) evaluates responses to learning interactions and determines both the knowledge state of the responding entity and the effectiveness of the interaction itself. This dual assessment is a key innovation of the present invention, as it enables the system to improve both the learner's knowledge and its own teaching effectiveness simultaneously.

The parameter updates module (113) modifies system behavior based on the assessment results. These modifications may include adjusting attention weights in the transformer model, refining difficulty progression curves, updating knowledge state representations, and modifying prompt templates.

The content generator (111) produces learning interactions (120) which may take various forms depending on the application context, including assessments, explanations, exercises, or combinations thereof. The bidirectional information flow between all components ensures continuous adaptation and improvement of the learning process.

### Iterative Learning Cycle

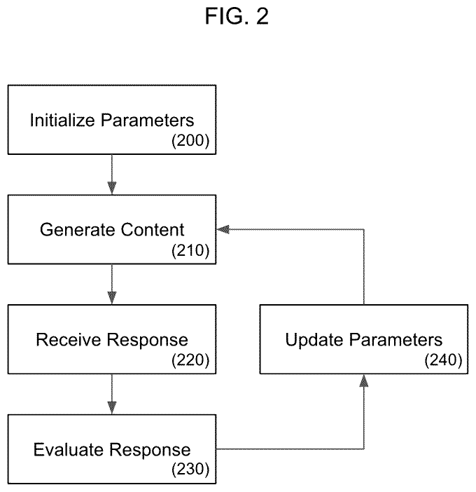

Turning to FIG. 2, an iterative learning cycle is depicted beginning with parameter initialization (200). This initialization establishes baseline values for the transformer model's weights, difficulty settings, and knowledge state representations.

The cycle proceeds through content generation (210), which produces learning materials based on current parameters. These materials are designed to target specific knowledge gaps, introduce new concepts, or reinforce previously learned material, depending on the current knowledge state and learning objectives.

After presenting the learning interaction, the system receives a response (220) from either a human learner or another machine learning system. The response is then evaluated (230) to determine both the knowledge state indicated by the response and the effectiveness of the learning interaction itself.

The evaluation results inform parameter updates (240), which modify the system's behavior for subsequent iterations. These updates may include increasing or decreasing difficulty levels, adjusting attention to specific concepts, or modifying the format of future interactions.

This cycle repeats continuously, with each iteration potentially increasing in complexity based on demonstrated mastery. The cyclic nature of the process enables progressive improvement in both learning outcomes and system effectiveness.

### Dual-Mode Operation

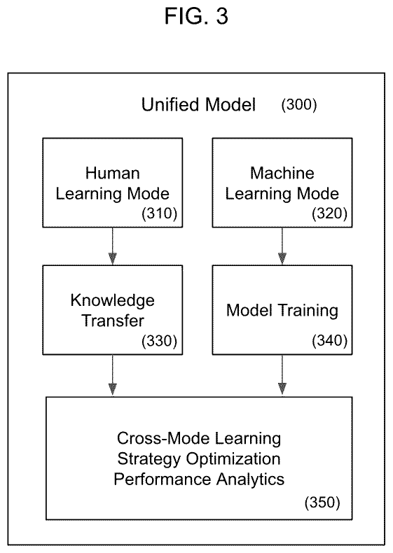

Referring to FIG. 3, a unified model (300) supporting dual-mode operation is illustrated. This architecture represents a significant innovation of the present invention: the ability to facilitate both human learning and machine learning through the same underlying system.

The system comprises a human learning mode (310) and a machine learning mode (320), operating in parallel. The human learning mode (310) generates content designed for human comprehension and engagement, including natural language explanations, interactive exercises, contextual feedback, and adaptation to individual learning styles.

In contrast, the machine learning mode (320) produces structured training data, assessment criteria, performance metrics, and learning parameters optimized for training other artificial intelligence systems. Despite these differences in output format, both modes share the same underlying transformer architecture and learning principles.

The human learning mode (310) connects to knowledge transfer components (330) specialized for human-centric learning, while the machine learning mode (320) connects to model training components (340) optimized for machine learning systems.

A cross-mode learning component (350) facilitates strategy optimization and performance analytics across both modes. This component enables the system to identify successful teaching strategies in one mode and apply them to the other, creating a synergistic relationship between human and machine learning approaches.

### Progressive Difficulty Adjustment

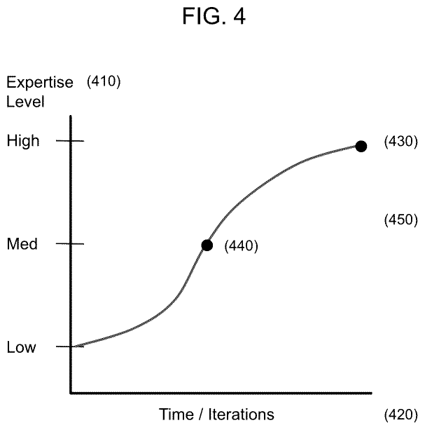

Turning to FIG. 4, a coordinate system shows expertise level (410) on the vertical axis and time or iterations (420) on the horizontal axis. A progressive learning curve (430) demonstrates the non-linear increase in difficulty as learners advance through the system.

Rather than implementing a linear progression, the system adjusts difficulty dynamically based on demonstrated mastery. Mastery points (440) indicate significant learning milestones where substantial increases in difficulty may occur.

Adaptation zones (450) show where difficulty adjustments take place based on performance metrics. In these zones, the system may temporarily decrease difficulty to reinforce concepts or increase difficulty to challenge the learner appropriately.

The curve's varying slope reflects the adaptive nature of the progression, with steeper sections indicating rapid advancement through well-understood concepts and more gradual sections representing challenging material requiring additional reinforcement.

### Knowledge State Tracking

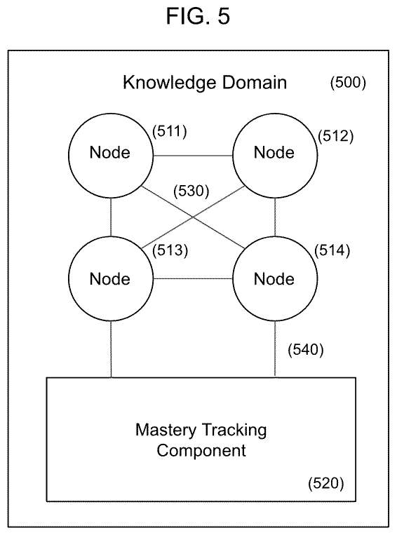

As shown in FIG. 5, the system maintains a knowledge domain structure (500) comprising interconnected knowledge nodes (511, 512, 513, 514). Each node represents a specific concept, skill, or competency within the domain, with node connections (530) indicating prerequisite relationships and learning pathways.

A mastery tracking component (520) continuously monitors proficiency levels for each node through tracking connections (540). This granular approach to knowledge representation allows the system to identify specific strengths and weaknesses, rather than relying on overall performance metrics.

The knowledge state tracking system enables precision targeting of learning interactions, ensuring that content generation focuses on the most relevant concepts for a given learner at a specific point in their learning journey. This targeting maximizes learning efficiency by addressing knowledge gaps while avoiding unnecessary repetition of mastered content.

### Meta-Learning Framework

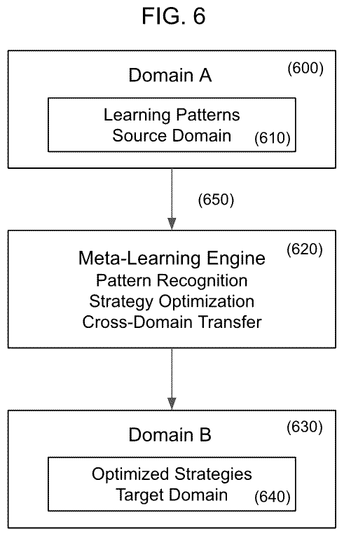

Referring to FIG. 6, a meta-learning framework is depicted with a source domain (600) containing initial learning patterns (610). These patterns may include successful teaching strategies, effective progression sequences, or engagement techniques that have proven effective in the source domain.

The meta-learning engine (620) processes these patterns through multiple mechanisms: pattern recognition to identify successful teaching approaches, strategy optimization to enhance effectiveness, and cross-domain transfer to apply insights across different fields of expertise.

The target domain (630) receives optimized strategies (640) that have been adapted for its specific requirements. Transfer pathways (650) facilitate bidirectional knowledge flow between domains, creating a continuous improvement cycle that benefits all domains managed by the system.

This meta-learning capability represents a significant advancement over prior art systems, which typically operate within single domains and cannot leverage insights across different fields of expertise. By identifying universal learning patterns, the present invention achieves greater efficiency and effectiveness than domain-specific approaches.

### Parameter Update Flow

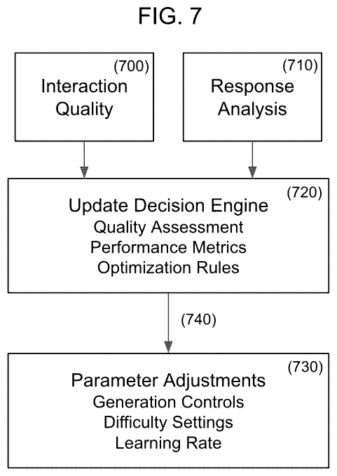

Turning to FIG. 7, the parameter update process begins with parallel inputs from interaction quality assessment (700) and response analysis (710). Interaction quality metrics may include engagement levels, clarity of presentation, and appropriateness of difficulty, while response analysis evaluates the correctness, completeness, and reasoning demonstrated in the learner's response.

These inputs feed into an update decision engine (720) that evaluates multiple factors including quality assessment, performance metrics, and optimization rules. The engine determines which parameters require adjustment and the magnitude of those adjustments based on comprehensive analysis of the learning interaction.

The parameter adjustments module (730) implements changes through various mechanisms, including modifying model weights, updating generation controls, adjusting difficulty settings, and tuning learning rates. These adjustments are applied with appropriate constraints to ensure system stability while enabling continuous improvement.

Flow indicators (740) show the progression of updates through the system, with information flowing from quality and response assessment through the decision engine to parameter implementations. This structured approach to parameter updates ensures consistent, predictable improvement in system performance over time.

### System Implementation

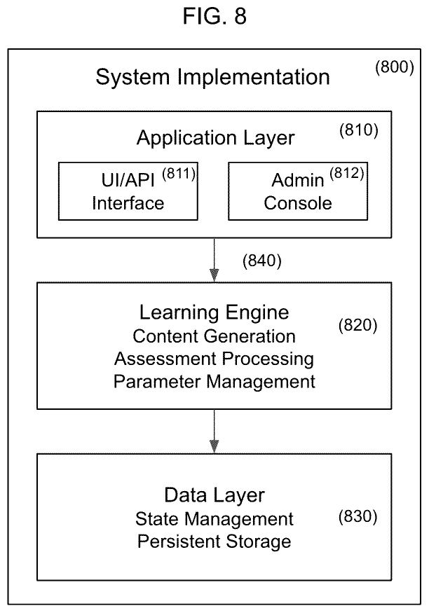

As illustrated in FIG. 8, the system implementation architecture (800) comprises three main layers. The application layer (810) contains the UI/API interface (811) and admin console (812), providing access points for learners and administrators respectively.

The learning engine (820) implements the core functionality described in previous figures, including content generation, assessment processing, and parameter management. This layer contains the transformer-based models and processing logic that enable the system's adaptive learning capabilities.

The data layer (830) handles state management and persistent storage, maintaining historical interaction data, knowledge state representations, and system parameters. This layer enables long-term learning analysis and system improvement by preserving relevant data across sessions.

Connecting pathways (840) show the flow of information between layers, ensuring that user interactions, learning outcomes, and system adjustments are properly coordinated throughout the architecture.

### Example Implementation

In one implementation of the present invention, a transformer-based language model with 70 billion parameters serves as the foundation for both content generation and assessment. The model is fine-tuned on domain-specific datasets to enhance performance in particular fields of expertise.

The system initializes with parameters tailored to beginner-level interactions in the specified domain. As learners engage with the system, their responses are evaluated in real-time, with results feeding into the parameter update process to continuously refine the learning experience.

In human learning mode, the system generates natural language explanations, interactive exercises, and contextual feedback, adapting to individual learning styles through analysis of engagement patterns and response characteristics. The difficulty progression is dynamically adjusted based on demonstrated mastery, with content focusing on identified knowledge gaps.

In machine learning mode, the same underlying architecture generates structured training data and assessment criteria for other AI systems. The cross-mode learning component identifies successful strategies from both modes, creating a synergistic relationship that enhances overall system performance.

The meta-learning capabilities enable the system to apply insights gained in one domain to others, accelerating the optimization process across multiple fields of expertise. This cross-domain learning represents a significant advancement over traditional single-domain systems.

### Method Embodiment

According to one embodiment, the method of the present invention comprises the following steps:

First, receiving a domain specification defining a field of expertise, including subject matter definitions, success criteria, key concepts, and evaluation parameters.

Second, initializing a transformer-based content generation model and an assessment model with appropriate parameters for the specified domain.

Third, executing an iterative learning cycle by generating learning interactions, receiving responses, evaluating both knowledge states and interaction quality, and updating system parameters.

Fourth, progressively increasing difficulty based on demonstrated mastery, with dynamic adjustments to maintain optimal challenge levels.

Fifth, maintaining a detailed knowledge state representation to track proficiency across multiple concepts and their relationships.

Sixth, applying meta-learning techniques to identify universal learning patterns and optimize teaching strategies across domains.

This method can be implemented for both human learners and machine learning systems, with appropriate adaptations for each target audience.

### System Embodiment

In a system embodiment, the present invention comprises one or more processors and memory storing instructions that, when executed, implement the method described above. The system includes interfaces for both human learners and machine learning systems, with appropriate input/output mechanisms for each mode of operation.

The system maintains persistent storage of learning histories, knowledge states, and system parameters, enabling long-term analysis and continuous improvement. Security measures ensure appropriate data protection and access controls.

The modular architecture allows for scaling and extension to additional domains without requiring fundamental redesign. New domains can be added through domain specification inputs, with the meta-learning framework facilitating knowledge transfer from existing domains to accelerate optimization.

### Advantages and Benefits

The present invention offers several advantages over prior art systems. By integrating content generation and assessment in a continuous cycle, it enables simultaneous improvement of both learning materials and learner knowledge. The dual-mode operation creates synergies between human and machine learning approaches, leveraging insights from each to enhance overall system performance.

The meta-learning framework enables efficient knowledge transfer across domains, reducing the time required to optimize for new fields of expertise. The dynamic difficulty adjustment maximizes learning efficiency by maintaining appropriate challenge levels without manual intervention.

For human learners, the system provides personalized, adaptive learning experiences that address specific knowledge gaps and learning styles. For machine learning applications, it generates optimized training data and assessment criteria tailored to specific AI systems.

Organizations implementing the system benefit from reduced training costs, accelerated expertise development, and improved knowledge retention across both human and machine learning contexts.

### Industrial Applicability

The present invention has broad industrial applicability across numerous sectors including education, corporate training, healthcare professional development, legal education, technical certification, and AI system training. In educational settings, it can provide personalized learning experiences at scale, addressing individual student needs while reducing instructor workload.

In corporate environments, the system can accelerate onboarding and skill development, reducing training costs while improving outcomes. Healthcare applications include medical education, continuing professional development, and clinical decision support training.

For artificial intelligence development, the system offers advanced training methodologies that accelerate the development of specialized AI systems through optimized learning interactions and assessment criteria.

### Additional Embodiments

While the preferred embodiments have been described above, the present invention may be embodied in many alternative forms. For example, the transformer-based models may be replaced with other neural network architectures while maintaining the iterative learning cycle and dual-mode operation. The system may be implemented in cloud-based environments, edge computing scenarios, or hybrid architectures depending on specific application requirements.

The invention may also be implemented with varying levels of human oversight, from fully automated operation to collaborative systems that incorporate human expertise in the parameter update process. Additional modes beyond human and machine learning may be implemented for specialized applications, while maintaining the core principles of iterative improvement and meta-learning.

The foregoing description has been presented for purposes of illustration and description. It is not intended to be exhaustive or to limit the invention to the precise forms disclosed. Obvious modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A computer-implemented method for progressive learning, comprising: receiving a domain specification defining a field of expertise; initializing a transformer-based content generation model and an assessment model; executing an iterative learning cycle by: generating, by the content generation model, a learning interaction comprising at least one of an assessment, an explanation, or an exercise; receiving a response to the learning interaction; evaluating, by the assessment model, the response to determine a knowledge state indicated by the response and a quality metric for the generated learning interaction; updating both parameters controlling subsequent content generation based on the quality metric and a difficulty level for subsequent learning interactions based on the knowledge state; and repeating the iterative learning cycle with the updated parameters and difficulty level, wherein the learning cycle progressively improves both the effectiveness of generated learning interactions and the knowledge state of the responding entity.

2. A system for unified human and machine learning, comprising: one or more processors; memory storing instructions that, when executed, cause the system to: maintain a transformer-based model capable of generating domain-specific content and assessing responses to the generated content; operate in at least two modes comprising a human learning mode wherein generated content facilitates human expertise development and a machine learning mode wherein generated content trains other artificial intelligence systems; for each mode: generate progressive learning interactions of increasing complexity, evaluate responses to determine both response quality and interaction effectiveness, and adjust subsequent content generation based on the evaluation, wherein the system improves its content generation capabilities through analysis of interactions in both modes.

3. A method for domain-independent expertise development, comprising: receiving specifications for multiple domains of expertise and corresponding success criteria; initializing a meta-learning framework comprising a cross-domain content generation component using transformer-based language models and a multi-domain assessment component; executing parallel learning cycles across different domains that synthesize common patterns, transfer successful strategies between domains, and optimize teaching methodologies based on cross-domain effectiveness; analyzing learning outcomes across domains to identify universal learning patterns; and automatically adapting content generation and assessment strategies based on aggregate cross-domain performance metrics, wherein the framework continuously enhances its teaching effectiveness through systematic analysis of learning patterns across multiple domains of expertise.

4. The method of claim 1, wherein the quality metric comprises: an engagement level with the learning interaction; an effectiveness at knowledge transfer; an appropriateness of difficulty level; and a clarity of presentation.

5. The method of claim 1, wherein updating parameters comprises: adjusting attention weights in the transformer model; modifying prompt templates; refining difficulty progression curves; and updating knowledge state representations.

6. The method of claim 1, further comprising: maintaining a history of learning interactions; analyzing patterns of successful knowledge transfer; identifying optimal progression pathways; and adapting generation strategies based on historical effectiveness.

7. The system of claim 2, wherein operating in human learning mode comprises: generating natural language explanations; providing interactive exercises; offering contextual feedback; and adapting to individual learning styles.

8. The system of claim 2, wherein operating in machine learning mode comprises: generating structured training data; creating quantifiable assessment criteria; providing performance metrics; and optimizing learning parameters through reinforcement learning.

9. The method of claim 3, wherein the cross-domain assessment component: tracks multiple dimensions of expertise across domains; identifies common knowledge patterns; predicts optimal learning pathways; and measures cross-domain learning efficiency.

10. The method of claim 3, wherein analyzing learning outcomes comprises: identifying universal teaching patterns; optimizing progression strategies across domains; adapting to diverse learning approaches; and improving content generation through meta-analysis.

11. The method of claim 3, wherein the framework: automatically transfers successful learning strategies between domains; identifies domain-independent expertise development patterns; continuously optimizes teaching methodology based on cross-domain results; and improves assessment accuracy through pattern recognition.

12. The system of claim 2, further comprising a real-time adaptation component that: continuously monitors learner engagement; dynamically adjusts difficulty levels; adapts content generation parameters in real-time; and incorporates immediate feedback into the learning cycle.

13. The method of claim 1, further comprising collaborative learning capabilities that: share effective teaching strategies across multiple instances of the system; aggregate effectiveness metrics across different domains; identify universal learning patterns through statistical analysis; and optimize knowledge transfer through collaborative refinement.
